(19) United States
(12) Patent Application Publication
(10) Pub. No.: US 2005/0171769 A1
(43) Pub. Date: Aug. 4, 2005

(54) Apparatus and method for voice activity detection

(75) Inventors: Nobuhiko Naka, Yokohama-shi (JP); Tomoyuki Ohya, Yokohama-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: NTT DoCoMo, Inc., Tokyo (JP)

(21) Appl. No.: 11/019,314

(22) Filed: Dec. 23, 2004

(30) Foreign Application Priority Data
Jan. 28, 2004 (JP) P2004-020351

(51) Int. Cl. G10L 11/06

(52) U.S. Cl. 704/214

(57) ABSTRACT

A voice activity detection apparatus enabling the decision on active interval accurately regardless of time elapse is sought. Apparatus 10 comprises autocorrelation calculating unit 11 calculating autocorrelation value of input signal, delay calculating unit 12 calculating delay for calculated autocorrelation value becoming maximum, noise deciding unit 13 deciding whether input signal is noise or not based on calculated delay, noise estimating unit 14 estimating noise from input signal, activity deciding unit 15 performing activity decision regarding input signal based on result of decision by noise deciding unit 13, noise estimated by noise estimating unit 14, and input signal, and a sound interval detecting unit 16 counting time duration of active interval based on decision result by deciding unit 15. In case of time duration of active interval reaches a predetermined period or more, noise estimating unit 14 changes noise estimating method such that input signal is likely decided as active.

### BACKGROUND OF THE INVENTION

1. Field of the Invention

The present invention relates to a voice activity detection apparatus and a voice activity detection method.

2. Related Background Art

Discontinuous transmission (DTX) is a technology commonly used in telephony services over the mobile and in telephony services over the Internet for the purpose of reducing transmission power or saving transmission bandwidth. In the DTX operation, inactive period in an input signal, such as silence and background noise, may be transmitted at lower bitrate compared with the bitrate for active period containing speech, music or special tones, or transmission may be stopped during such inactive period. Voice activity detection (VAD), which is one of the key components of DTX operation, decides whether the current period of the input signal to be encoded contains only inactive information or not.

For example, the voice activity detection apparatus described in Non-patent Document 1 listed below estimates a background noise from the input signal by the predetermined noise estimating method and uses the ratio of the input signals to the estimated background noise (S/N ratio: signal to noise ratio) for activity detection.
[Non-patent Document 1] 3GPP TS 26.094 V3.0.0 (http://www.3gpp.org/ftp/Specs/html-info/26094.htm)

### SUMMARY OF THE INVENTION

However, the above mentioned conventional voice activity detection apparatus has the following problem. Generally, the performance of the noise estimation may be degraded with the lapse of time, when the characteristics of the noise signal is not stationary. And such performance degradation of the noise estimation likely occurs, especially at the time when the active period continues for a long time, because the input signal contains not only the background noise, and thus it is difficult to estimate the characteristics of the noise signal correctly during such period of time. For the above mentioned conventional voice activity decision apparatus, the activity decision with the unmatched estimated background noise leads that the accuracy of the activity detection is deteriorated with the lapse of time (especially, when the active period continues for a long time). As a result, the above mentioned conventional voice activity detection apparatus may decide the active period as inactive with the lapse of time (especially, when the sound interval continued for a long time).

The objective of the present invention is therefore to provide a voice activity detection apparatus and a voice activity detection method, which can perform activity decision of the input signal accurately regardless of the passage of time.

For solving the above mentioned problem, the voice activity detection apparatus of the present invention comprises an activity detection means for decides whether an input signal is active or not according to a predetermined decision condition; a time measurement means for measuring time duration of the active period on the basis of the result of decision by the activity detection means, wherein the activity detection means eases the decision condition so that the input signal is likely decided as active when the time duration of the active interval measured by the time measurement means becomes equal to or longer than a predetermined period of time.

Additionally, for solving the above mentioned problem, an activity detection method is provided to perform the activity decision of the input signal according to a predetermined decision condition, wherein there is executed that a process of easing the decision condition so that the input signal is likely decided as active, when a time duration of the active interval becomes equal to or longer than a fixed period of time.

And by easing the decision condition such that the input signal is likely decided as active, when a time duration of the active interval becomes equal to or longer than a predetermined period of time, number of fault detections, i.e., the active period is decided as inactive, can be reduced, even when the accuracy of the noise estimation is degraded with the lapse of time.

And in the activity detection apparatus of the present invention, the activity decision means detecting the activity of the input signal on the basis of a noise estimated by a predetermined noise estimating method is provided, wherein the activity decision means changes the noise estimating method so that the input signal is likely decided as active, when the time duration of the active interval measured by the time measurement means becomes equal to or longer than a predetermined period of time.

Herein, by changing the noise estimating method so that the input signal is likely detected as active when time duration of the active interval measured by the time measurement means becomes equal to or longer than a predetermined period of time, the number of fault detections can be reduced, even when the accuracy of the noise estimation is degraded with the lapse of time. Additionally, the performance of the noise estimation can be improved by adapting the estimation method according to the non-stationary characteristic of noise.

In the voice activity detection apparatus and the voice activity detection of the present invention, there is provided that when a time duration for active period becomes equal to or longer than a fixed period of time, there is eased the decision condition such that the input signal is likely decided as active, whereby there can be reduced the number of fault decisions, even when the accuracy of the noise estimation is degraded with the lapse of time. As a consequence, the decision method can detect the active period of time of the input signal accurately regardless of the passage of time.

### BRIEF DESCRIPTION OF THE DRAWINGS

FIG. 1 shows a configuration diagram of the voice activity detection apparatus according to the embodiment.

FIG. 2 shows a flow chart showing the operation of the voice activity detection apparatus according to the embodiment.

### DESCRIPTION OF THE PREFERRED EMBODIMENTS

A voice activity detection apparatus according to an embodiment of the present invention is explained in reference to the drawings.

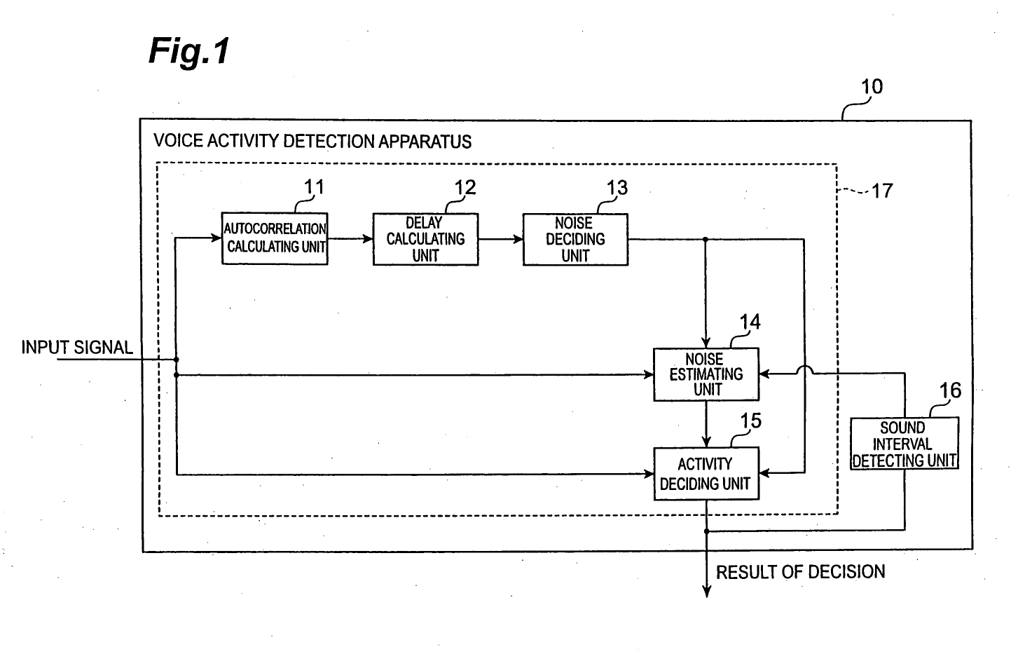

First, the configuration of the voice activity detection apparatus according to this embodiment is explained. FIG. 1 is a block diagram of the voice activity detection apparatus according to this embodiment.

A voice activity detection apparatus 10 according to this embodiment is, physically, configured as a computer system comprising a CPU (central processing unit), a memory, input devices such as a mouse and a keyboard, a displaying device such as a display, a storage device such as a hard disk, a radio communication unit that executes data communication with an external equipment via radio communication, and the like. And as shown in FIG. 1, the voice activity detection apparatus 10 is, functionally, provided with an autocorrelation calculating unit 11, a delay calculating unit 12, a noise deciding unit 13, a noise estimating unit 14, an activity decision unit 15, and a sound interval detecting unit 16 (time measurement means). A voice activity detection means 17 is composed of the autocorrelation calculating unit 11, the delay calculating unit 12, the noise deciding unit 13, the noise estimating unit 14, and the activity decision unit 15. Next, each constituent element of the voice activity detection apparatus 10 is explained in detail.

The autocorrelation calculating unit 11 calculates autocorrelation values of the input signal. More specifically, the autocorrelation calculating unit 11 calculates an autocorrelation value c(t) for the delay t of an input signal x(n), according to the following equation (1).

$$c ( t ) = \frac{{\sum }_{n = 0}^{N - 1} x ( n ) x ( n - t )}{\sqrt{{\sum }_{n = 0}^{N - 1} {x}^{2} ( n )} \sqrt{{\sum }_{n = 0}^{N - 1} {x}^{2} ( n - t )}} \qquad ( 1 )$$

Where, x(n) (n=0, 1, . . . , N) is the n-th value obtained by sampling an input signal every fixed time interval (e.g., 1/8000 sec) over a fixed time (e.g., 20 msec). Furthermore, the autocorrelation value c(t) is obtained as discrete values every fixed time interval (e.g., 1/8000 sec) over a fixed time (e.g., 18 msec).

Here, it is not always necessary that the autocorrelation calculating unit 11 calculates the autocorrelation value strictly in accordance with the above mentioned equation (1). For example, the autocorrelation calculating unit 11 can be designed to calculate the autocorrelation value based on the perceptually weighted input signal as widely used in speech encoders.

The delay calculating unit 12 calculates a delay corresponding to the maximum autocorrelation value among the autocorrelation values calculated by the autocorrelation calculating unit 11. More specifically, the delay calculating unit 12 searches autocorrelation values in a predetermined interval (for example, in the case of AMR, t=18 to 143) and calculates a delay in which the autocorrelation value becomes a maximum value.

The noise deciding unit 13 decides whether the input signal is noise or not based on the delay calculated by the delay calculating unit 12. The noise deciding unit 13, for example, decides whether the input signal is noise or not by utilizing time variations t_max (t) (1≦t≦T) of the delay t_max calculated by the delay calculating unit 12, where t is a dependent variable showing a time. More specifically, the noise deciding unit 13 decides that the input signal is not noise, when the condition given by (2) is met for a predetermined period of time (qualitatively speaking, the variation of the delay is small for the predetermined period of time), Conversely, the noise deciding unit 13 decides that the input signal is noise when the condition given by (2) is not met within the predetermined period of time,
|t_{—}max(t)−t_{—}max(t−1)|≦d (2)

In (2), d denotes a predetermined threshold of the delay difference. The noise deciding unit 13 may decide whether the input signal is noise or not by using a procedure other than the above mentioned procedure.

The noise estimating unit 14 estimates a noise from the input signal. More specifically, the noise estimating unit 14, for example, estimates a noise by (3).
noiseₘ₊₁(n)=(1−α)·noiseₘ(n)+α·inputₘ₋₁(n) (3)
where, noiseₘ(n) is the estimated noise, inputₘ(n) is an input signal, n denotes the frequency band, m denotes the time (frame), and α is a coefficient. The noiseₘ(n) represents the estimated noise of the n-th frequency band at time (frame) m. The noise estimating unit 14 changes the coefficient α in (3) in accordance with the result of decision by noise deciding unit 13. When it is decided by the noise deciding unit 13 that the input signal is not noise, the noise estimating unit 21 sets the coefficient α in (3) to 0 or a value α1 close to 0 in such a manner as to cause no increase in the power of the estimated noise. On the other hand, when it is decided by the noise deciding unit 13 that the input signal is noise, the noise estimating unit 21 sets the coefficient α in the above equation (3) to 1 or a value α2 (α2>α1) near 1 so as to cause the estimated noise to be close to the input signal. The noise estimating unit 21 may be designed to estimate a noise from the input signal using a procedure other than the above procedure.

The activity decision unit 15 performs activity decision on the basis of the result of decision by the noise deciding unit 13, the input signal, and the noise estimated by the noise estimating unit 14. More specifically, the activity decision unit 15, for example, calculates an S/N ratio (signal to noise ratio) from the noise estimated by the noise estimating unit 14 and the input signal, (more accurately, calculates an integrated value or an average value of the S/N ratio at each frequency band). And the activity decision unit 15 compares the calculated S/N ratio with a threshold value, and decides that the input signal is active in the case where the S/N ratio is larger than the threshold value, and decides that the input signal is inactive in the case where the S/N ratio is equal to the threshold value or less. The threshold may be adapted by the result of decision at the noise deciding unit 13. The threshold value for the case that the noise deciding unit 13 decides the input signal is not noise is set to be smaller than the threshold value for the case that the noise deciding unit 13 decides the input signal is noise. In the case that the noise deciding unit 13 decides that the input signal is not noise, the possibility of detecting signals having small S/N ratios (i.e., signals buried in the noise) as active increases. The activity decision unit 15 can decide the activity of the input signal by using a procedure other than the above mentioned procedure. For example, the above mentioned threshold value is fixed irrespective of the result of decision by the noise deciding unit 13, and the activity decision unit 15 may decide the activity of the input signal on the basis of the input signal and the noise estimated by the noise estimating unit 14. It is also possible that the activity decision unit 15 decides whether the input signal is active or not by utilizing additional information of the input signal (power, a spectrum envelope, the number of zero-crossing, and the like). Here, inactive refers to the meaningless sound, such as silence and background noise, while active refers to a sound containing human voice, music or tones.

The sound interval detecting unit 16 measures time duration of the active interval, based on the result of decision by the activity decision unit 15. Specifically, the sound interval detecting unit 16 measures the time duration of the active interval by directly using the result of the activity decision unit 15. Alternatively, the sound interval detecting unit 16 can measure the time duration of the active interval by measuring a time that the speech encoding unit (not shown) is executing its speech encoding by an encoding rate being equal to a fixed threshold value or more (in case of the AMR, an encoding rate being 4.75 kbps or more). When the input signal has been decided as active by the activity decision unit 15, the input signal is encoded the larger bitrate is used for encoding the input signal in the speech encoding unit.

The noise estimating unit 14 changes a noise estimating method such that the input signal is likely decided as active, when the time duration of the active interval measured by the sound interval detecting unit 16 becomes a predetermined period of time or more. More specifically, the noise estimating unit 14 sets the estimated noise noiseₘ(n) at unit time before (1 frame before) in (3) to the initial value noise₀(n), when the time duration of the active interval measured by the sound interval detecting unit 16 becomes the predetermined period of time or more. Since the initial value noise₀(n) has been set to a sufficiently small value compared with the input signal of the active interval, the estimated noise becomes small_by setting the estimated noise noiseₘ(n) at the unit time before (1 frame before) in (3) to the initial value noise₀(n). Therefore, the input signal is likely decided as active by the activity decision unit 15.

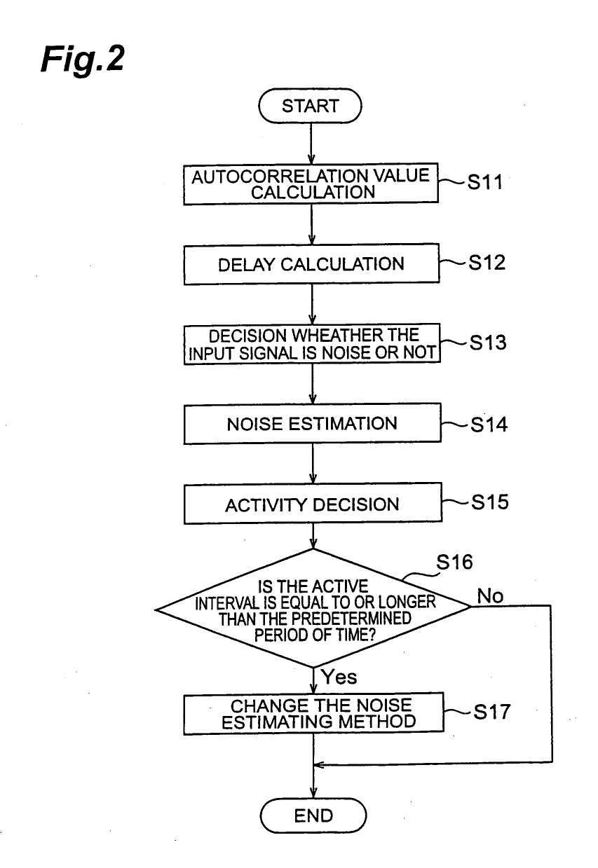

Next, the operation of the voice activity detection apparatus according to this embodiment is explained, and the voice activity detection method according to this embodiment is also explained. FIG. 2 is a flow chart showing the operation of the voice activity detection apparatus according to this embodiment.

When the input signal is inputted to the voice activity detection apparatus 10, first, the autocorrelation values of the input signal are calculated by the autocorrelation calculating unit 11 (step S11). More specifically, the each autocorrelation value c(t) for delay t of the input signal x(n) is calculated by (1).

After the autocorrelation values of the input signal has been calculated by the autocorrelation calculating unit 11, a delay corresponds to maximum autocorrelation value among the autocorrelation values calculated over the predetermined delay interval by the autocorrelation calculating unit 11 is calculated by the delay calculating unit 12 (step S12).

Once the delay is obtained by the delay calculating unit 12, it is decided whether an input signal is noise or not by the noise deciding unit 13 based on the delay calculated by the delay calculating unit 12 (step S13). More specifically, the noise deciding unit 13 decides that the input signal is not noise, when the condition given by (2) is met for a predetermined period of time. Conversely, the noise deciding unit 13 decides that the input signal is not noise, when the condition given by (2) is not met within the predetermined period of time.

Next, the noise is estimated from the input signal by the noise estimating unit 14 (step S14). More specifically, the noise is estimated by (3), where the coefficient α is adapted according to the result of decision by noise deciding unit 13. When it is decided by the noise deciding unit 13 that the input signal is not noise, the coefficient α is set to 0 or a coefficient α1 close to 0 so as not to increase the level of the estimated noise. On the other hand, when it is decided by the noise deciding unit 13 that the input signal is noise, the coefficient is set to 1 or a coefficient α2 close to 1 (α2>α1) so as to make the level of the estimated noise close to the input signal.

After the noise is estimated by the noise estimating unit 14, the activity decision unit 15 decides the activity of the input signal based on the result of decision by the noise deciding unit 13, the input signal, and the noise estimated by the noise estimating unit 14 (step S15). More specifically, for example, an S/N ratio (signal to noise ratio) is calculated from the noise estimated by the noise estimating unit 14 and the input signal, and the calculated S/N ratio is compared with a predetermined threshold value. It is then decided that the input signal is active when the S/N ratio is larger than the threshold value or that the input signal is inactive when the S/N ratio is equal to or less than the threshold value.

The time duration of the active interval is measured by the sound interval detecting unit 16. Specifically, the time duration of the active interval is measured by directly using the result of decision of the activity decision unit 15. Alternatively, the time duration of the active interval may be measured by using the time that the bitrate used in the speech encoding part (not shown in the figure) is higher than the certain threshold.

When the time duration of the active interval measured by the sound interval detecting unit 16 become the predetermined time or more (Yes at step S16), the noise estimating method is changed such that the input signal is likely decided as active (step S17). More specifically, when the time duration of the sound interval measured by the sound interval detecting unit 16 become the predetermined period of time or more, the estimated noise noiseₘ(n) at the unit time before (1 frame before) in (3) is set to the initial value noise₀(n) at the noise estimating unit 14. Since the initial value noise₀(n) is set to a sufficiently small value compared with the input signal in the active interval, the estimated noise becomes small by setting the estimated noise noiseₘ(n) at unit time before (1 frame before) in (3) to the initial value noise₀(n), and thus the input signal is likely decided as active at the activity decision unit 15.

Next, the effects of the voice activity detection apparatus according to this embodiment are explained. The voice activity detection apparatus 10 according to this embodiment measures the time duration of the active interval by the sound interval detecting unit 16, and when the time duration of the active interval becomes a predetermined period of time or more, the noise estimating unit 14 changes the noise estimating method such that the input signal is likely decided as active. More specifically, the estimated noise noiseₘ(n) at unit time before (1 frame before) in (3) is set to the initial value noise₀(n). Therefore, the number of times of fault decision, i.e., active period of the input signal decided as inactive, can be decreased even when the accuracy of the noise estimation is deteriorated with the passage of time. As a result, the activity of the input signal can be decided correctly regardless of the passage of time.

In the voice activity detection apparatus 10 according to this embodiment, when the time duration of the active interval measured by the sound interval detecting unit 16 becomes predetermined period of time or more, the noise estimating method in the noise estimating unit 14 is changed such that the input signal is likely decided as active. However, when the time duration of the active interval becomes a predetermined period of time or more, several modified embodiments can be conceived, within the technical thought of the present invention, in that the deciding condition whether the input signal is active or not is eased such that the input signal is likely decided as active. For example, when the time duration of the active interval measured by the sound interval detecting unit 16 become a predetermined period of time or more, the autocorrelation calculating method in the autocorrelation calculating unit 11, the delay calculating method in the delay calculating unit 12, the noise deciding method in the noise deciding unit 13, and the activity deciding method in the activity deciding unit 15 can be changed. More specifically, when the time duration of the active interval measured by the sound interval detecting unit 16 become a predetermined period of time or more, usage of the parameters for the activity detection, such as the autocorrelation values, the spectrum envelope, the delay, the estimated noise power, the S/N ratio, may be changed, or these parameters may be reset to the initial values.

The present invention is applicable to a voice activity detection apparatus for deciding whether an input signal is active including human voice or inactive in which information is not needed to transmit, typically used in mobile telephony services or the Internet telephony services.

It is obvious that the embodiments of the invention may be varied in many ways. Such variations are not to be regarded as a departure from the spirit and scope of the invention, and all such modifications as would be obvious to one skilled in the art are intended for inclusion within the scope of the following claims.

1. A voice activity detection apparatus comprising:
an activity decision means for deciding whether an input signal is active or not according to a predetermined decision condition;
a time measurement means for measuring time duration of the active interval on the basis of the result of decision by the activity decision means,
wherein the activity decision means eases the decision condition so that the input signal is likely decided as active when the time duration of the sound interval measured by the time measurement means becomes equal to or longer than a predetermined period of time.

2. The voice activity detection apparatus according to claim 1,
wherein the activity decision means decides the activity of the input signal on the basis of a noise estimated by a predetermined noise estimating method, wherein the activity decision means changes said noise estimating method so that the input signal is likely decided as active when the time duration of the sound interval measured by the time measurement means becomes equal to or longer than a predetermined period of time,

3. A voice activity detection method adopted for deciding the activity of an input signal according to a predetermined decision condition,
wherein there is executed a process of easing the decision condition so that the input signal is likely decided as active when the time duration for the active interval becomes equal to or longer than a predetermined period of time.
